(19) United States
(12) Patent Application Publication
(10) Pub. No.: US 2026/0192240 A1
(43) Pub. Date: Jul. 9, 2026

(54) METHOD FOR OPERATING A PLANT FOR PRODUCING CARBON DIOXIDE

(71) Applicant: Siemens Energy Global GmbH & Co. KG, München (DE)

(72) Inventors: Lukas Biyikli, Ratingen (DE); Suhel Ahmad, Duisburg (DE)

(21) Appl. No.: 19/133,739

(22) PCT Filed: Nov. 6, 2023
(86) PCT No.: PCT/EP2023/080766

§ 371 Date: May 29, 2025

(30) Foreign Application Priority Data
Dec. 2, 2022 (DE) 10 2022 213 028.6

(51) Int. Cl. B01D 53/14; B01D 53/18

(52) U.S. Cl. CPC B01D 53/1475; B01D 53/1425; B01D 53/18; B01D 2257/504; B01D 2258/0283

(57) ABSTRACT

The invention relates to a plant for producing carbon dioxide (CO2) that includes a separation system connected to a gas mixture of flue gas and CO2. The separation system separates CO2 and water vapor without condensing water before entry into a preheater. During operation, the separation system uses steam from a steam line. The plant further includes a carbon dioxide line connected to the separation system, a preheater to increase the temperature of CO2, and a multi-stage compressor to increase the temperature and pressure of CO2. After compression, CO2 passes through a steam generator, where its thermal energy generates steam. The cooled CO2 is recycled to subsequent compressor stages. Steam generated is supplied to the separation system. The plant also includes separators to remove condensed water and may feature additional dewatering units. The CO2 produced can be processed for transportation via pipelines.

### BACKGROUND

The invention relates to a plant and to a method of operating a plant.

The invention relates more particularly to a plant and to a method for separation and processing of carbon dioxide (CO₂) for transport in a pipeline.

It is known that there is a need to reduce carbon dioxide (CO₂) emissions from the operation of power plants and other processes. Separating out CO₂ is considered in this context to be an important factor for achievement of the global aim of lowering CO₂ emissions to a minimum level.

The International Energy Agency (IEA) predicts that the amount of CO₂ separated out could rise by 2050 from currently 50 million tons per year to 7600 million tons per year, in order to achieve climate goals.

In order to separate carbon dioxide (CO₂) out of the off gas, as in a flue gas for example, the only technology that is currently commercially available and on a large scale is the amine system. Amine systems require considerable amounts of low-pressure steam and hence heat for the process and are quite costly, which makes CO2 separation often appear economically unattractive to operators.

A further aspect is that, after sequestration, the carbon dioxide (CO₂) usually has to be transported over large distances if the reservoir or utilization is not in the vicinity. For this purpose, pipeline transport in the supercritical phase is often regarded as a good approach. In order to bring the carbon dioxide (CO₂) into the supercritical phase, it has to be compressed from virtually atmospheric pressure to supercritical pressure (above 73 bar and 31° C.), typically between 100 and 200 bar.

The compression releases a considerable amount of heat, which remains unutilized at present owing to the low temperature level.

Depending on the method by which the amine system is used, there are different potential heat sources. Some processes are exothermic, such that waste heat flows can be utilized for low-pressure (LP) steam provision. But if it is not the case and there is no alternative heat source, it is necessary to install a fuel-fired or electrical boiler. Frequently, natural gas boilers are used, which consume large amounts of gas and also produce additional carbon dioxide (CO₂), which likewise has to be separated out and hence leads to an even higher demand for energy and capital costs for the amine system.

With regard to the heat of compression, the aim is to utilize it sensibly and possibly combine it with the LP steam provision required for the amine plant. However, the low-value heat first has to be converted to high-value heat. One possible approach is the use of a small number of intermediate coolers between the compression stages, such that the carbon dioxide (CO₂) is cooled only when it is above the temperature at which the heat can be utilized for LP steam provision. However, the carbon dioxide (CO₂) is then cooled back to atmospheric temperature, such that the amount of steam that can be generated is comparatively small and the heat is only partly utilized. If 100% of the heat is to be utilized and steam production is to be maximized, a high-temperature heat pump may be used. However, this is associated with distinctly higher capital costs and space requirements.

The carbon dioxide (CO₂) coming out of the amine system generally includes a small amount of water vapor. This is achieved in that the amine system is designed with a desorber top condenser. The water vapor present in the carbon dioxide (CO₂) is condensed in the desorber top condenser. However, this leaves the latent heat of the water vapor unutilized.

The invention proceeds from the idea that it is possible to dispense with the desorber top condenser. This means that the carbon dioxide (CO₂) coming out of the amine system has a comparatively high proportion of water vapor. This mixture typically contains about 50 mol % of water and 50 mol % of carbon dioxide (CO₂), and is at a pressure between 1 and 4 bar and a temperature between 90 and 130° C.

### SUMMARY

Against this background, an object of the invention is to provide a plant and a method for provision of carbon dioxide (CO₂) at optimal cost.

A further object of the invention is to maximize heat recovery for low-pressure (LP) steam provision with minimum costs and space requirement.

These objects are achieved by a plant for providing carbon dioxide (CO₂), comprising a separating plant, wherein the separating plant is fluidically connected to a gas mixture of flue gas and carbon dioxide (CO₂), wherein the separating plant is designed such that the carbon dioxide (CO₂) present in the flue gas is separated out, wherein the separating plant in operation is operable with steam from a steam conduit, wherein the stripper or desorber top condenser in the separating plant (2) is dispensed with, further comprising a first carbon dioxide conduit which is fluidically connected to the separating plant and out of which the carbon dioxide (CO₂) separated in the separating plant flows in operation, further comprising a preheater through which the carbon dioxide conduit leads and which is designed such that the temperature of the carbon dioxide (CO₂) is increased, further comprising a multistage compressor fluidically connected on the inlet side to the carbon dioxide conduit coming from the preheater, wherein, after one stage, the temperature and pressure of the carbon dioxide (CO₂) is increased, wherein, after the stage, the carbon dioxide (CO₂) is conducted via a conduit through a steam generator, wherein the steam generator is designed such that water supplied to the steam generator generates steam by means of energy exchange with the thermal energy of the carbon dioxide (CO₂) coming out of the compressor after a stage, wherein the carbon dioxide cooled in the steam generator is recycled into the compressor for a next stage, wherein the steam generated in the steam generator is fluidically connected to the separating plant via the steam conduit, wherein the carbon dioxide (CO₂) flowing out of the compressor after the stage flows through a first separator, wherein the separator is designed to dewater the carbon dioxide (CO₂) coming out of the compressor stage.

The object directed to the method is achieved by the steps of:
fluidically supplying a gas mixture of flue gas and carbon dioxide (CO₂) to a separating plant,
separating the carbon dioxide (CO₂) and water vapor (H2O) in the separating plant,
feeding the mixture of carbon dioxide (CO₂) and water vapor (H2O) to a preheater, wherein the mixture is heated in the preheater,
conducting the mixture heated in the preheater onward in a first stage of a multistage compressor, wherein the pressure and temperature of the mixture are increased in the first stage,
conducting the heated mixture onward after the first stage into a steam generator, wherein the thermal energy of the mixture is utilized for generation of steam in the steam generator,
performing a recycling step, wherein, in the recycling step, the carbon dioxide (CO₂) cooled in the steam generator is conducted into a further stage of the compressor, wherein, in the further stage, the temperature and pressure of the carbon dioxide (CO₂) is increased,
conducting the heated carbon dioxide (CO₂) onward after the further stage into a further steam generator, wherein the thermal energy of the carbon dioxide (CO₂) is utilized for generation of steam in the further steam generator,
repeating the recycling step up to a last stage,
conducting the carbon dioxide (CO₂) flowing out of the last stage onward through the preheater,
conducting the carbon dioxide (CO₂) flowing out of the preheater into an output conduit,
wherein the steam generated in the steam generator is fluidically connected via the steam conduit to the separating plant,
wherein separators and a dewatering unit are disposed between the stages of the compressor, wherein the separators are designed to separate out condensed water and the dewatering unit is designed to remove the remaining water content in the carbon dioxide.

A feature of the invention is the compressor, which typically comprises six to eight stages for a compression from atmospheric to supercritical pressure. This means that the process of compression and the provision of steam in the waste heat boiler (HRSG) does in fact proceed repeatedly, according to the final number of stages required to achieve the exit pressure.

The preheater and all the other downstream components are used only once, irrespective of the number of stages.

According to the invention, the carbon dioxide (CO₂) is cooled only to such an extent that the heat can still be utilized for steam provision in the waste heat boiler. This temperature is generally 5-10° C. above the final steam temperature required for the amine system, but this depends on the ultimate construction of the heat exchanger. However, this means that the carbon dioxide (CO₂) is not cooled back to atmospheric temperature before going into the next compressor stage. This enables steam provision after each compression stage with the same number of heat exchangers/HRSGs as in conventional operation.

In fact, this process, however, could commence only after the second or even third compressor stage since the carbon dioxide (CO₂) first has to be heated up from the atmospheric exit temperature downstream of the amine system to the utilizable temperature level. In order to further maximize steam provision, high temperature of the carbon dioxide (CO₂) after the last HRSG can then be utilized in order to preheat the carbon dioxide (CO₂) at the compressor inlet to the utilizable temperature level, such that the whole compressor from the intake to the exit is operated at the temperature level at which steam can be provided, such that the steam provision can be commenced even after the first compressor stage.

According to the invention, the high water content of the carbon dioxide (CO₂) coming from the amine system is not reduced prior to entry into the compressor. In the typical modern-day configuration, what is called a stripper or desorber top condenser is used for this purpose, in order to condense out significant amounts of the water upstream of the compressor. The invention stipulates that this condenser is dispensed with. The condenser is typically part of the separating plant. In this way, it is possible to capture the latent heat of the condensing steam at the utilizable temperature level within the steam generator for steam provision between the compressor stages. The condensation commences in the steam generator downstream of the compression stage, which compresses the stream to above about 15 bar. The condensed water is separated out in a separator beyond the corresponding heat exchanger/HRSG.

Thereafter, the stream is transferred into the next process stage, where further water condenses and is thus separated out during the cooling in the steam generator, before ultimately being dehydrated in a dehydration system (typically triethylene glycol, but other technologies may also be employable) to the final permissible water content (for example for a pipeline).

Typically, the stream has to be cooled back down to virtually atmospheric temperature in order to enter the dehydration system. Since the stream in the steam generator can be cooled only to about 5-10° C. above steam temperature, the stream downstream of the steam generator or separator still contains considerable heat, which is utilized in order to preheat the stream at the compressor inlet, in order to maximize steam production.

The dry carbon dioxide that leaves the drying system is still at atmospheric temperature level. In order to improve the recovery of heat even within the last process stage, the carbon dioxide is heated back to the utilizable temperature level by the stream that leaves the compressor and has to be cooled back down to atmospheric temperature.

The solution reduces the energy requirement of the amine system considerably, which, depending on the alternative heat source, leads to a fuel saving, and also to a carbon dioxide (CO₂) saving when a fossil fuel is used, and therefore in this connection also to a CAPEX saving in the amine system since less carbon dioxide (CO₂) has to be separated out, while no additional equipment and only a little additional drive output are required.

The advantage of the invention lies in maximization of heat utilization and recovery of the heat of compression of carbon dioxide (CO₂), almost without additional equipment and space requirement.

A further advantage is the reduction of the external heat requirement for LP steam provision for the amine system.

A further advantage arises from the significant saving of cooling water for the carbon dioxide (CO₂) compressor since the feed water for the steam provision in the amine system is used for the intermediate cooling.

A further advantage is achieved by the potential carbon dioxide (CO₂) saving when fossil fuel is used as heat source for the boiler.

### BRIEF DESCRIPTION OF THE DRAWINGS

The above-described properties, features and advantages of this invention and the way in which they are achieved will be more clearly and distinctly comprehensible in connection with the description of the working examples that follows, these being elucidated in detail together with the drawings.

Identical components or components having the same function are identified by the same reference numerals here.

Working examples of the invention are described hereinafter with reference to the drawings. These are not intended to illustrate the working examples to scale; instead, the drawing, where useful for elucidation, is in schematic and/or slightly distorted form. With regard to supplementations of the teachings that are immediately apparent in the drawing, reference is made to the relevant prior art.

FIG. 1 is a schematic diagram of one embodiment of a plant of the invention.

### DETAILED DESCRIPTION

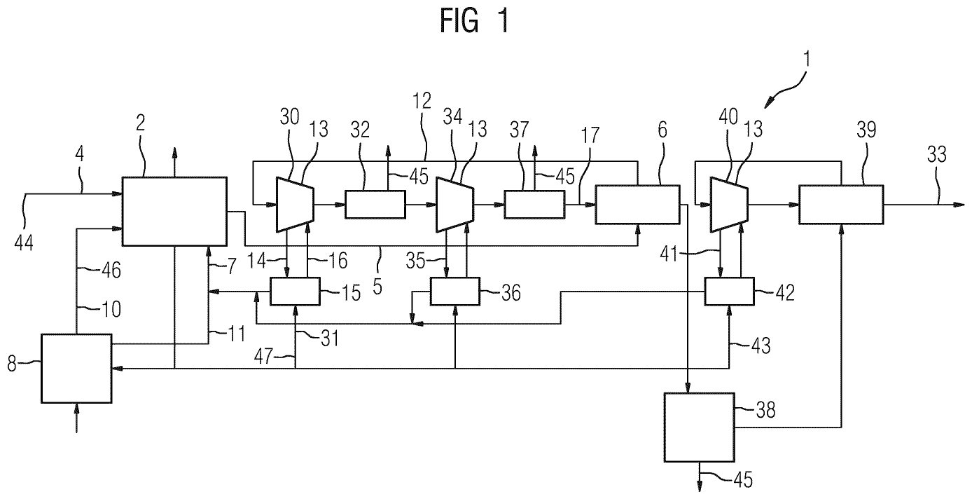

FIG. 1 shows a schematic diagram of one embodiment of a plant 1.

The plant 1 is designed to provide carbon dioxide (CO₂) and comprises a separating plant 2. The separating plant 2 is fluidically connected via a conduit 4 to a gas mixture 44 composed of flue gas and carbon dioxide (CO₂). The separating plant 2 is designed such that the carbon dioxide (CO₂) present in the flue gas 44 is separated. The separated carbon dioxide (CO₂) flows via a first carbon dioxide conduit 5 out of the separating plant 2 through a preheater 6. In the preheater 6, the temperature of the carbon dioxide (CO₂) is increased.

The first carbon dioxide conduit 5 is fluidically connected to the separating plant 2. The separating plant 2 here is designed as an amine plant. The carbon dioxide (CO₂) coming out of the separating plant, however, is still mixed here with a comparatively large amount of water vapor. The ratio between carbon dioxide (CO₂) and the water vapor here may be about 50 mol % of water and 50 mol % of CO₂. The water vapor present in the carbon dioxide (CO₂) accordingly still contains thermal energy which is utilized in accordance with the invention.

In operation, the separating plant 2 is operated with steam from a steam conduit 7. The carbon dioxide (CO₂) 46 generated in the boiler 8 is likewise optionally fed into the separating plant 2 via a conduit 10 when a fossil fuel is being used. The steam raised in the boiler 8 is conducted into the separating plant 2 via a conduit 11.

The carbon dioxide (CO₂) heated downstream of the preheater 6 is fed via a conduit 12 to a multistage compressor 13. The multistage compressor 13 is fluidically connected on the inlet side to the carbon dioxide conduit 5 coming out of the preheater 6.

In the compressor 13, the heated carbon dioxide (CO₂) is fed to a first stage 30, wherein the temperature and pressure of the carbon dioxide (CO₂) are increased in the first stage 30.

After the first stage 30, the carbon dioxide (CO₂) is fed via a conduit 14 to a steam generator 15, which may be designed as an HRSG (heat recovery steam generator).

The steam generator 15 is designed such that water 47 supplied to the steam generator 15 is converted to steam by energy exchange with the thermal energy of the carbon dioxide (CO₂) coming from the compressor 13 after a stage 30.

The compressor 13 has five to ten stages, especially six to nine and very particularly seven or eight stages.

The carbon dioxide (CO₂) cooled in the steam generator 15 is recycled into the stage 30 via a conduit 16 into the compressor 13. This is done several times, i.e. the stream is fed to multiple stages in the process stage 30, with use of the thermal energy in the carbon dioxide (CO₂) for generation of steam in the steam generator 15 after each stage. All that are shown in FIG. 1 for reasons of clarity are a compressor stage 30, a steam generator 15, a conduit 14 toward the steam generator 15, and a conduit 16 from the steam generator 15 toward the compressor 13 and toward process stage 30. Illustration of the individual conduits toward the steam generator 15 and back to the compressor 13 have been dispensed with for reasons of clarity.

Considerable amounts of the water vapor present in the carbon dioxide begin to condense in the last steam generator 15. Before the carbon dioxide (CO₂) flows through the stages 34 of the compressor 13, it flows through a separator 32. In the separator 32, water 45 is separated out of the carbon dioxide (CO₂) and removed via a conduit.

The steam generated in the steam generator 15 and in the further steam generator 36 is fluidically connected to the separating plant 2 via the steam conduit 7.

The carbon dioxide (CO₂) flowing out of the compressor 13 after stage 34 flows via a conduit 17 through the preheater 6. Before the carbon dioxide (CO₂) flows through the preheater 6, it flows through a second separator 37. In the second separator 37, water 45 is separated out of the carbon dioxide (CO₂) and removed via a conduit.

Downstream of the preheater 6, the carbon dioxide (CO₂) flows through a dewatering unit 38, where the dewatering unit 38 is designed to dewater the carbon dioxide (CO₂) coming out of the preheater 6. At the same time, the water 45 separated in the dewatering unit 38 is removed via a dewatering conduit.

The additional dewatering unit 38 is designed, for example, as a triethylene glycol (TEG) system.

The carbon dioxide (CO₂) that flows out downstream of the additional dewatering unit 38 flows through a further preheater 39, where the temperature of the carbon dioxide (CO₂) is increased. Downstream of the preheater 39, the carbon dioxide (CO₂) flows through the next stage 40 of the compressor 13, increasing the temperature and the pressure of the carbon dioxide (CO₂).

The thermal energy of the carbon dioxide (CO₂) is used to generate steam for the separating plant 2 in a further steam generator 42.

The carbon dioxide (CO₂) generated and provided in the plant 1 is then processed, for example, for transportation in a pipeline 33.

1. A plant for providing carbon dioxide (CO2), comprising:
a separating plant, wherein the separating plant is fluidically connected to a gas mixture of flue gas and CO2, wherein the separating plant is designed such that the CO2 and water vapor present in the flue gas are separated out,
wherein the separating plant in operation is operable with steam from a steam conduit;
a first carbon dioxide conduit which is fluidically connected to the separating plant and out of which the CO2 separated in the separating plant flows in operation;
a preheater through which the first carbon dioxide conduit leads and which is designed such that a temperature of the CO2 is increased; and
a multistage compressor fluidically connected on an inlet side to the carbon dioxide conduit coming from the preheater,
wherein, after one stage, the temperature and pressure of the CO2 is increased,
wherein, after the stage, the CO2 is conducted via a conduit through a steam generator,
wherein the steam generator is designed such that water supplied to the steam generator generates steam by means of energy exchange with a thermal energy of the CO2 coming out of the compressor after a stage,
wherein the carbon dioxide cooled in the steam generator is recycled into the compressor for a next stage,
wherein the steam generated in the steam generator is fluidically connected to the separating plant via the steam conduit,
and
wherein the CO2 flowing out of the compressor after the first process stage flows through a first separator, wherein the separator is designed to separate out the water condensed in the last steam generator.

2. The plant as claimed in claim 1,
wherein the CO2 generated in the plant is processed for transportation in a pipeline.

3. The plant as claimed in claim 1,
wherein the separating plant takes a form of an amine plant.

4. The plant as claimed in claim 1,
wherein the compressor has five to ten stages, especially six to nine and very particularly seven or eight stages.

5. The plant as claimed in claim 1,
wherein a next stage of the compressor is disposed downstream of the first separator, wherein the temperature and pressure of the CO2 is increased in the next stage,
wherein, after the next stage, the CO2 is conducted via a conduit through a further steam generator,
wherein the further steam generator is designed such that water supplied to the further steam generator generates steam by means of energy exchange with the thermal energy of the CO2 coming out of the compressor after the next stage,
wherein the carbon dioxide cooled in the steam generator is recycled into the compressor.

6. The plant as claimed in claim 5,
wherein the carbon dioxide CO2 flowing out of the compressor after the next stage flows through a second separator, wherein the second separator is designed to separate out the water condensed in the steam generator.

7. The plant as claimed in claim 1, having an additional dewatering unit (38) fluidically coupled to the preheater.

8. The plant as claimed in claim 7,
wherein the additional dewatering unit takes a form of a triethylene glycol (TEG) system.

9. The plant as claimed in claim 7,
having a further preheater fluidically coupled to the additional dewatering unit.

10. The plant as claimed in claim 9,
wherein the compressor has an additional stage fluidically coupled to the further preheater, wherein the temperature and the pressure of the CO2 is increased in the additional stage.

11. The plant as claimed in claim 10,
wherein, after the additional stage, the CO2 is conducted via a conduit through a steam generator,
wherein the steam generator is designed such that water supplied to the steam generator generates steam by means of energy exchange with the thermal energy of the CO2 coming out of the compressor after the additional stage,
wherein the carbon dioxide cooled in the steam generator is recycled into the compressor for a next stage.

12. A method of providing carbon dioxide (CO2) comprising:
fluidically supplying a gas mixture of flue gas and CO2 to a separating plant,
separating the CO2 and water vapor in the separating plant,
feeding the CO2 to a preheater, wherein the CO2 is heated in the preheater,
conducting the CO2 heated in the preheater onward into a first stage of a multistage compressor, wherein a pressure and temperature of the CO2 are increased in the first stage,
conducting the heated CO2 onward after the first stage into a steam generator, wherein a thermal energy of the CO2 is utilized for generation of steam in the steam generator,
performing a recycling step, wherein, in the recycling step, the CO2 cooled in the steam generator is conducted into a further stage of the compressor, wherein, in the further stage, the temperature and pressure of the CO2 is increased,
conducting the heated CO2 onward after the further stage into a further steam generator, wherein the thermal energy of the CO2 is utilized for generation of steam in the further steam generator,
repeating the recycling step up to a last stage,
conducting the CO2 flowing out of the last stage onward through the preheater,
conducting the CO2 flowing out of the preheater into an output conduit,
wherein the steam generated in the steam generator is fluidically connected via the steam conduit to the separating plant,
wherein separators and a dewatering unit are disposed between the stages of the compressor, wherein the separators are designed to separate out condensed water and the dewatering unit is designed to remove the remaining water content in the carbon dioxide.

13. The method as claimed in claim 12,
wherein an additional dewatering unit is disposed downstream of the preheater.

14. The method as claimed in claim 13,
wherein the additional dewatering unit takes a form of a triethylene glycol (TEG) system.
